(19) United States
(12) Patent Application Publication
(10) Pub. No.: US 2007/0192717 A1
(43) Pub. Date: Aug. 16, 2007

(54) Methods and systems for context based digital calendar serving as personal memory footprint organizer and artistic expression domain

(76) Inventors: Li Gong, Santa Clara, CA (US); Jenny Yi, Santa Clara, CA (US)

Correspondence Address: Li Gong, 745 Nicholson Ave., Santa Clara, CA, 95051, US

(21) Appl. No.: 11/307,538

(22) Filed: Feb. 12, 2006

(51) Int. Cl. G06F 3/048

(52) U.S. Cl. 715/765

(57) ABSTRACT

Systems and methods for using digital calendar to timely and relevantly preserve and associate personal digital creations that include all drawings, photos, videos, files, journals, and any personal thoughts documented in blogs, notes, and/or digital files in any digital formats in user specified and/or created context environment, and to freely and creatively view, edit, assemble, distribute, share, print, and publish those personal digital memory footprints stored in the context digital calendar system in both digital and non-digital ways. The context based calendar system serves as a portable digital center for planning, collecting, preserving, documenting, and publishing important events, thoughts, digital creations, and memories for a person or a group of people in addition to usual calendar functions. The system can be used as either standalone software application, or be embedded within other software applications, and/or be used as web based service(s).

### DESCRIPTION

1. Technical Field

The present invention generally relates to methods and systems for context based digital calendar serving as personal memory footprint organizer and artistic expression domain

2. Background

Printed Calendars are still being used a lot for its convenience, beautiful background pictures, easy to use, and user expression friendly (writing note, drawing etc.) features. But they are hard to preserve, difficult to input more information, and impossible to attach and associate both digital (pictures, files, videos, journals etc.) and none-digital (birthday cards etc.) creations together.

Digital Calendars on personal computer/organizer, phone, web etc. are easy to use for event scheduling and notification purposes. And they are portable. But on the other hand, they are weak on graphic rendering and can not be easily used to organize personal digital life experiences, such as photos, videos, and writings associated with timely events.

Meanwhile, Digital photo/video/audio creation and sharing, blogging, and digital scrapbook etc. services/applications are becoming more popular for their convenience, easy to use, and user friendly features. But these services/applications are often taken out of context and can only be used as a piece meal for one's life. And they are hard to assemble together later on by end users for specific needs to create and share rich and passionate stories.

For example, a mom wants to document everything related to her daughter from the get-go of her pregnancy. She wants to write a poem to her daughter in one day, create a song for her daughter in another day, write a long thoughtful dialogue to share with her daughter when she grows up, post photos for her daughter's first birthday party and create a journal for it, and assemble all the important digital memories into a book 20 years later and give it as a wedding gift to her daughter. The list can go on and on. No applications and systems existing today can easily do all of these for this loving and caring mom in easy and intuitive ways.

So, what is needed is a method and system for easily and timely documenting, preserving, re-creating and sharing personal digital memories in any digital formats in a user context aware environment using digital calendars.

A further needs exists for artistically expressing one's collected digital memories within a digital memorabilia calendar environment in both digital and non-digital ways, such as through offline media: printers, printing services, publishing house etc.

A still further need exists for easily assembling, editing, and displaying stored personal digital creations/memories according to user specified needs.

The present invention is directed towards solving these problems.

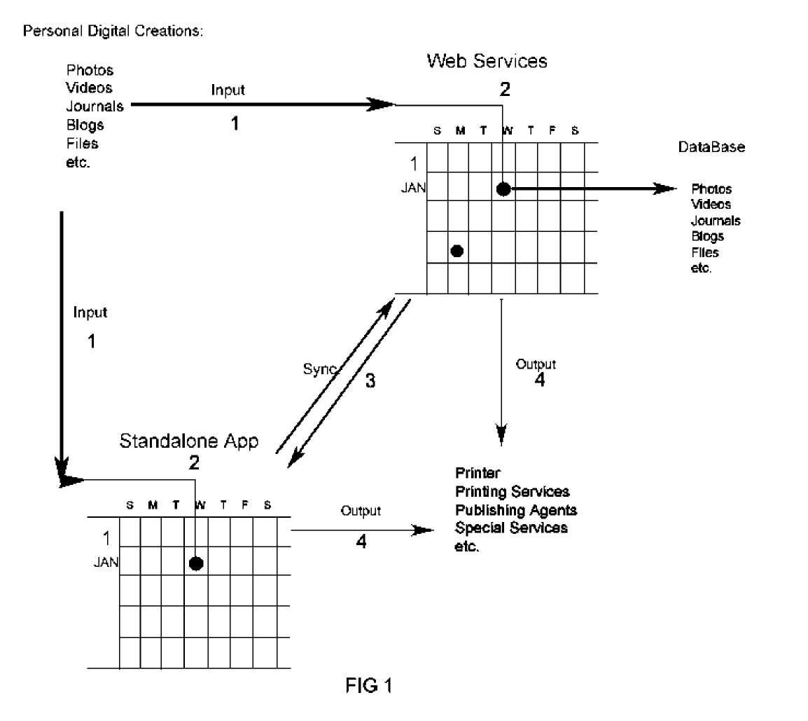

FIG. 1. depicts a rendering context calendar system. In Step One, User inputs his digital creations into either a web based context calendar system or a standalone calendar application stored on a computer, PDA, or phone device. In Step Two, the context calendar application/service associates those inputted personal digital creations with user specified context, a combination of time and/or events with any newly added user specified content, such as blogs, journals, and special notes etc., and displays such association either in a specified time frame in any calendar view styles or in overlay style over the context calendar itself. In Step Three, the Standalone or embedded context calendar application and the web based context calendar system synchronize with each other for newly updated context calendar information. In Step Four, both Standalone/embedded context calendar application and the web based context calendar system output user created stories or memory footprints to printers, special printing services either online or offline based, publishing houses either online or offline based, and other special services.

What is claimed is:

1. A method of creating context based calendar serving as personal memory footprint organizer and artistic expression domain, the method comprising: inputting personal digital creations into context based digital calendar applications/services and in the context based digital calendar applications associating and/or editing those digital creations according to user specified contents.

2. The method of claim 1 wherein the personal digital creations comprises one or more of digital drawings, photos, videos, audios, journals, writings, blogs, notes etc.

3. The method of claim 1 wherein the inputting personal digital creations into context based digital calendar applications involves one or more of selecting the time(s) or event(s) or a pre-selected group of digital memories on the calendar and then associating related personal digital creations into the context calendar applications/services so that those times and/or event(s) and/or a pre-selected group of digital memories are thereafter associated with those personal digital creations, or loading personal digital creations into the context calendar applications/services and then assigning time(s) and/or event(s) and/or a group of digital memories to establish the associations.

4. The method of claim 1 wherein the associating and/or editing those digital creations according to user specified contents comprises one or more of tagging drawings, photos, videos and audios, journaling, designing background pictures, putting special notes/writings, bloging, designing information layout and appearance, and creating more related information within the context of the digital calendar.

5. A method of organizing context based calendar serving as personal memory footprint organizer and artistic expression domain, the method comprising: viewing, editing, assembling, sharing, distributing, printing, and/or publishing those digital creations stored in the context based digital calendar applications/services.

6. The method of claim 5 wherein sharing and distributing those stored digital creations stored in the context based digital calendar applications/services comprises one or more of synchronizing digital creations among standalone/embedded context calendar applications and the web based context calendar services, and allowing a Social Networking group access and view selected personal creations through either trusted context web services social group or directly sending of selected personal creations through any available digital and non-digital methods.

7. The method of claim 6 wherein a Social Networking Group comprises of one or more of users who have valid accounts with the web based context calendar services and who have granted tailored access permissions to each other.

8. The method of claim 6 wherein directly sending of selected personal creations through any available digital and non-digital methods comprises of any email, instant messaging, VolP, and/or printer methods.

9. The method of claim 5 wherein viewing, editing and assembling those stored personal digital creations comprises one or more of specified time(s) and/or event(s) related personal digital creations in any specified order(s), and such re-generated story or stories based on a set of personal digital creations are displayed in user specified digital scrapbook style and stored in user specified location(s) within the context calendar applications/services for references.

10. The method of claim 5 wherein editing those stored personal digital creations comprised any inputting of new information and modifying existing information.

11. The method of claim 10 wherein information comprises one or more of digital drawings, photos, videos, audios, journals, writings, blogs, notes, layouts background pictures etc.

12. The method of claim 5 wherein printing and publishing those store digital creations comprises of one or more of printers, special printing services both online or offline, special scrapbook services both online and offline, and publishing houses.

13. A system for context based calendar applications/services serving as personal memory footprint organizer and artistic expression domain, comprising: A web based context calendar system, wherein user authentication is required; a plurality of computer systems connected to each other and/or to the web based context calendar system through communication networks; a plurality of inputting computing devices and/or digital file uploading, downloading, transferring and sharing services connected to the web based context calendar system and/or a plurality of computer systems through communication networks; a plurality of outputting computing devices and/or digital file uploading, downloading, transferring and sharing services connected to the web based context calendar system and/or a plurality of computer systems through communication networks. Both the web based context calendar system and the plurality of computer systems contain software applications for performing a method of creating and utilizing the context based digital calendar serving as personal memory footprint organizer and artistic expression domain, the method comprising: A user installs the standalone context based digital calendar application on a plurality of computer systems and/or creates account in the web based context calendar system, wherein all the systems can talk to each other and sync up information; the user inputs or uploads any digital creations into computer systems with the context based calendar application and/or the web based context calendar system using any exiting digital media creating, loading, uploading, downloading, transferring and sharing means and methods; then the user uses the application based or the web service based context calendar functions to freely view, edit, assemble, distribute, share, print, and publish those stored personal digital memory footprints in both digital and/or non-digital ways within the context of the digital calendar environment.
